(19) United States
(12) Patent Application Publication
(10) Pub. No.: US 2014/0362606 A1
(43) Pub. Date: Dec. 11, 2014

(54) DC-DC CONVERSION DEVICE

(71) Applicant: FUJI ELECTRIC CO., LTD., Kawasaki-shi (JP)

(72) Inventor: Masakazu Gekinozu, Matsumoto-city (JP)

(73) Assignee: FUJI ELECTRIC CO., LTD., Kawasaki-shi (JP)

(21) Appl. No.: 14/372,322

(22) PCT Filed: Dec. 25, 2012
(86) PCT No.: PCT/JP2012/083407

§ 371 Date: Jul. 15, 2014

(30) Foreign Application Priority Data
Mar. 5, 2012 (JP) 2012-047888

(51) Int. Cl. H02M 3/335

(52) U.S. Cl. CPC H02M 3/33569
USPC 363/17

(57) ABSTRACT

A DC-DC conversion device includes four semiconductor switch elements 101 to 104 in a full-bride configuration on the primary side of a transformer 2. With this configuration, it is possible to increase the turn ratio of a primary winding 21 and secondary winding 22 of the transformer 2 and thus increase a voltage V21 generated in the primary winding 21, and to decrease a current flowing through the primary winding 21 of the transformer 2 and thus decrease breaking currents of the semiconductor switch elements 101 to 104. Consequently, it is possible, by using an input voltage detection circuit 9 and an oscillator circuit 8, to prevent a decrease in power conversion efficiency particularly when an input DC voltage from a power source 1 is high and the switching frequencies of the semiconductor switch elements 101 to 104 are high.

### TECHNICAL FIELD

The present invention relates to a DC-DC conversion device which generates an alternating current voltage in a primary winding of a transformer based on an input direct current voltage from a direct current power source, and generates a direct current voltage by rectifying and smoothing an alternating current voltage generated in a secondary winding of the transformer.

### BACKGROUND ART

FIG. 3 is a circuit diagram showing a heretofore known configuration example of this kind of DC-DC conversion device. In the DC-DC conversion device, a series arm wherein semiconductor switch elements 101 and 102 are connected in series is connected in parallel to a direct current power source 1. Herein, a diode 111 and a capacitor 121 are connected in parallel to the semiconductor switch element 101, and a diode 112 and a capacitor 122 are connected in parallel to the semiconductor switch element 102. Further, a resonating reactor 3, a primary winding 21 of a transformer 2, and a resonating capacitor 4 are inserted in series between a common node between the semiconductor switch elements 101 and 102 and the negative electrode of the direct current power source 1.

As means for rectifying an alternating current voltage generated in a secondary winding 22 of the transformer 2, a full-wave rectifier circuit 13 of a full-bridge configuration formed of diodes 131 to 134 is connected on the secondary side of the transformer 2. An output voltage of the full-wave rectifier circuit 13 is smoothed by a smoothing capacitor 5 and output from the DC-DC conversion device.

An output voltage detection circuit 6, a pulse-width modulation control circuit 7, an oscillator circuit 8, and an input voltage detection circuit 9 configure control means for controlling so that the voltage value of a direct current voltage output by the DC-DC conversion device maintains a target value.

More particularly, the output voltage detection circuit 6 is a circuit which detects the output voltage of the DC-DC conversion device. The oscillator circuit 8 is a circuit which outputs cyclic synchronizing signals to the pulse-width modulation control circuit 7. The pulse-width modulation control circuit 7 is a circuit which generates a first pulse, which turns on the semiconductor switch element 101, each time a synchronizing signal is given from the oscillator circuit 8, and subsequently, generates a second pulse, which turns on the semiconductor switch element 102, in a period until a next synchronizing signal is given. The pulse-width modulation control circuit 7, having a pulse-width modulation function, carries out the control of an ON duty, which is the ratio of the pulse width of the first pulse in the cycles of the first and second pulses, in response to an increase and decrease in the output voltage, detected by the output voltage detection circuit 6, from the target value, and thus maintains the output voltage value of the DC-DC conversion device at the target value. The input voltage detection circuit 9 is a circuit which detects an input direct current voltage given to the DC-DC conversion device from the direct current power source 1. Further, the oscillator circuit 8 has a configuration wherein the higher the input direct current voltage detected by the input voltage detection circuit 9, the higher the frequency of the synchronizing signals is made, and the lower the value of the input direct current voltage, the lower the frequency of the synchronizing signals is made.

(a) of FIG. 4 is a waveform diagram showing an operation example of the DC-DC conversion device when at a low input voltage, i.e., when the input direct current voltage given from the direct current power source 1 is low, while (b) of FIG. 4 is a waveform diagram showing an operation example of the DC-DC conversion device when at a high input voltage, i.e., when the input direct current voltage is high. Each of (a) and (b) of FIG. 4 shows the respective waveforms of a drain-source voltage V101 of the semiconductor switch element 101, a drain-source voltage V102 of the semiconductor switch element 102, a drain current I101 of the semiconductor switch element 101, a drain current I102 of the semiconductor switch element 102, a voltage V4 of the resonating capacitor 4, a voltage V21 of the primary winding 21 of the transformer 2, and currents I131, I132, I133, and I134 flowing respectively through the diodes 131, 132, 133, and 134. Hereafter, a description will be given, referring to (a) and (b) of FIG. 4, of an operation of the DC-DC conversion device shown in FIG. 3.

As heretofore described, the pulse-width modulation control circuit 7 alternately generates the first pulse which turns on the semiconductor switch element 101 and the second pulse which turns on the semiconductor switch element 102. When the semiconductor switch element 101 is turned on, a resonant current flows via a path from the direct current power source 1 through the semiconductor switch element 101, the resonating reactor 3, and the primary winding 21 of the transformer 2 to the resonating capacitor 4, and the resonating capacitor 4 is charged by the resonant current. During this time, a differential voltage between the input direct current voltage from the direct current power source 1 and the voltage V4 of the resonating capacitor 4 is applied to the primary winding 21 of the transformer 2 and the resonating reactor 3. Further, a voltage corresponding to the voltage V21 of the primary winding 21 is generated in the secondary winding 22 of the transformer 2, and the smoothing capacitor 5 is charged by the voltage via the diodes 131 and 134. Further, direct current power is supplied to an unshown load from the smoothing capacitor 5.

Next, when the semiconductor switch element 101 is turned off, the resonant current having flowed so far is commutated to the capacitors 121 and 122, and the drain-source voltages V101 and V102 of the semiconductor switch elements 101 and 102 rise or drop gradually.

When the drain-source voltage V101 of the turned-off semiconductor switch element 101 reaches the input direct current voltage from the direct current power source 1, the resonant current is commutated to the diode 112. At this time, by the semiconductor switch element 102 being turned on, a resonant current I102 flows via a path from the resonating capacitor 4 through the primary winding 21 of the transformer 2 and the resonating reactor 3 to the semiconductor switch element 102, and discharging of the resonating capacitor 4 is carried out by the resonant current I102. At this time, the voltage V4 of the resonating capacitor 4 is applied to the primary winding 21 of the transformer 2 and the resonating reactor 3. Further, a voltage corresponding to the voltage V21 of the primary winding 21 is generated in the secondary winding 22 of the transformer 2, and the smoothing capacitor 5 is charged by the voltage via the diodes 133 and 132. Further, direct current power is supplied to an unshown load from the smoothing capacitor 5.

Next, when the semiconductor switch element 102 is turned off, the resonant current having flowed so far is commutated to the capacitors 121 and 122, and the drain-source voltages V101 and V102 of the semiconductor switch elements 101 and 102 rise and drop gradually.

When the drain-source voltage V102 of the turned-off semiconductor switch element 102 reaches the input direct current voltage from the direct current power source 1, the resonant current is commutated to the diode 111. At this time, by the semiconductor switch element 101 being turned on, a resonant current flows via a path from the direct current power source 1 through the semiconductor switch element 101, the resonating reactor 3, and the primary winding 21 of the transformer 2 to the resonating capacitor 4, and the resonating capacitor 4 is charged by the resonant current.

By this kind of operation being repeated, another direct current power isolated from the direct current power source 1 is generated based on the input direct current power from the direct current power source 1, and supplied to an unshown load via the smoothing capacitor 5.

Herein, when at a low input voltage, the semiconductor switch elements 101 and 102 each operate with an ON duty of on the order of 0.5, as shown in (a) of FIG. 4, and the current I101 flowing through the semiconductor switch element 101 and the current I102 flowing though the semiconductor switch element 102 change into a sine wave shape.

When a load condition changes, and the output voltage value of the DC-DC conversion device is off the target value, the pulse-width modulation control circuit 7 changes the respective pulse widths (ON duties) of the first pulse which turns on the semiconductor switch element 101 and the second pulse which turns on the semiconductor switch element 102, and returns the output voltage value of the DC-DC conversion device to the target value.

When at a high input voltage, the semiconductor switch elements 101 and 102 each operate with an ON duty of on the order of 0.5, as shown in (b) of FIG. 4. This point is the same as when at a low input voltage.

However, when at a high input voltage, the oscillator circuit 8 raises the frequencies of the first and second pulses which respectively turn on the semiconductor switch elements 101 and 102. As a result of this, switching of the semiconductor switch element 101 from ON to OFF and switching of the semiconductor switch element 102 from ON to OFF occur respectively at a timing at which the current I101 flowing through the semiconductor switch element 101 is in the vicinity of the peak of the sine wave and at a timing at which the current I102 flowing through the semiconductor switch element 102 is in the vicinity of the peak of the sine wave. Because of this, a breaking current flowing through the turned-off semiconductor switch elements 101 and 102 increases compared with when at a low input voltage.

### CITATION LIST

### Patent Literature

PTL 1: JP-A-2002-209382

### SUMMARY OF INVENTION

### Technical Problem

As above, the heretofore known DC-DC conversion device has the problem that the breaking current of the semiconductor switches of a circuit on the primary side of the transformer increases particularly when a high voltage is input, and thus that power conversion efficiency decreases.

The invention, having been contrived bearing in mind the heretofore described circumstances, has an object of providing technological means whereby it is possible to decrease a breaking current flowing through semiconductor switches of a circuit on the primary side of a transformer, and thus prevent a decrease in the power conversion efficiency of a DC-DC conversion device particularly when a high voltage is input.

### Solution to Problem

The invention provides a DC-DC conversion device which generates an alternating current voltage in a primary winding of a transformer based on an input direct current voltage given from a direct current power source, rectifies and smooths an alternating current voltage generated in a secondary winding of the transformer, and outputs a direct current voltage, the device being characterized by including a first series arm, formed by connecting first and second semiconductor switch elements in series, wherein the first semiconductor switch element is provided on the positive side of the direct current power source, and the second semiconductor switch element is provided on the negative side of the direct current power source; a second series arm, formed by connecting third and fourth semiconductor switch elements in series, wherein the third semiconductor switch element is provided on the positive side of the direct current power source, and the fourth semiconductor switch element is provided on the negative side of the direct current power source; first to fourth capacitors connected in parallel to the first to fourth semiconductor switch elements; first to fourth diodes connected in parallel to the first to fourth semiconductor switch elements; a resonating reactor and resonating capacitor, as well as the primary winding of the transformer, inserted in series between a common node between the first and second semiconductor switch elements and a common node between the third and fourth semiconductor switch elements; an input voltage detection circuit which detects an input direct current voltage given to the DC-DC conversion device from the direct current power source; and pulse generating means which alternately and cyclically generates a first pulse which turns on the first and fourth semiconductor switch elements and a second pulse which turns on the second and third semiconductor switch elements, and which causes the frequencies of the first and second pulses to rise when the input direct current voltage is high and drop when the input direct current voltage is low, based on a result of the input direct current voltage detection in the input voltage detection circuit, so that a constant direct current voltage is output from the DC-DC conversion device without depending on the input direct current voltage.

According to the invention, the alternating current voltage is applied to the primary winding of the transformer by the pair of first and fourth semiconductor switch elements and the pair of second and third semiconductor switch elements being alternately turned on. Herein, charging of the resonating capacitor in the period in which the pair of first and fourth semiconductor switch elements is turned on, and charging of the resonating capacitor in the period in which the pair of second and third semiconductor switch elements is turned on, are carried out in a direction opposite to each other. Consequently, with the DC-DC conversion device, it is possible to increase a turn ratio which is the ratio of the number of turns of the primary winding of the transformer to the number of turns of the secondary winding, and thus increase a voltage generated in the primary winding. Herein, a current flowing through the primary winding of the transformer is proportional to the reciprocal of the turn ratio of the transformer. Consequently, according to the invention, it is possible to increase the turn ratio of the transformer, and thus decrease the current flowing through the primary winding of the transformer, and it is thereby possible to decrease breaking currents flowing through the first to fourth semiconductor switch elements.

### BRIEF DESCRIPTION OF DRAWINGS

FIG. 1 is a circuit diagram showing a configuration of a DC-DC conversion device which is one embodiment of the invention.

FIG. 2 is a waveform diagram showing waveforms of individual portions of the DC-DC conversion device.

FIG. 3 is a circuit diagram showing a configuration of a heretofore known DC-DC conversion device.

FIG. 4 is a waveform diagram showing waveforms of individual portions of the DC-DC conversion device.

### DESCRIPTION OF EMBODIMENTS

Hereafter, a description will be given, referring to the drawings, of embodiments of the invention.

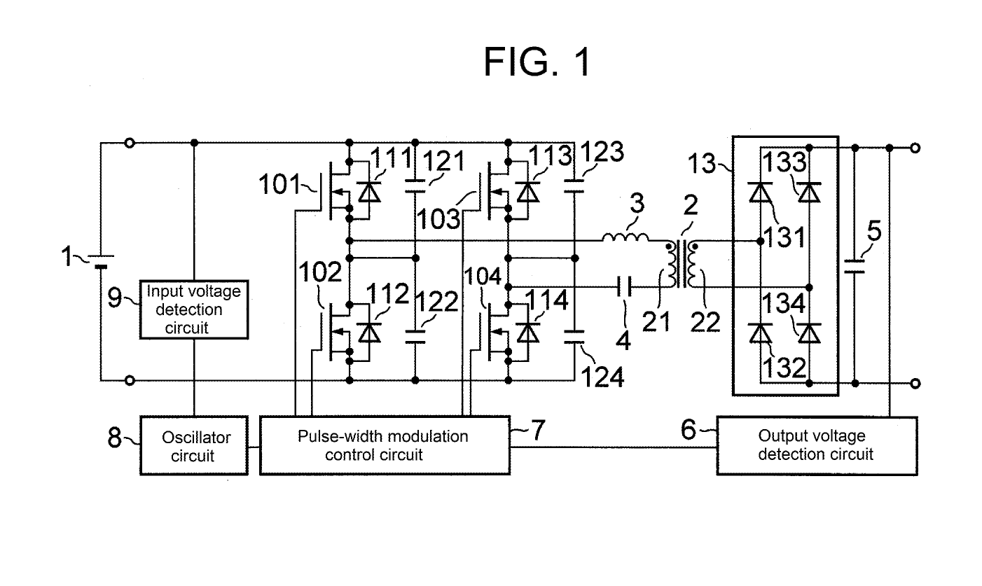

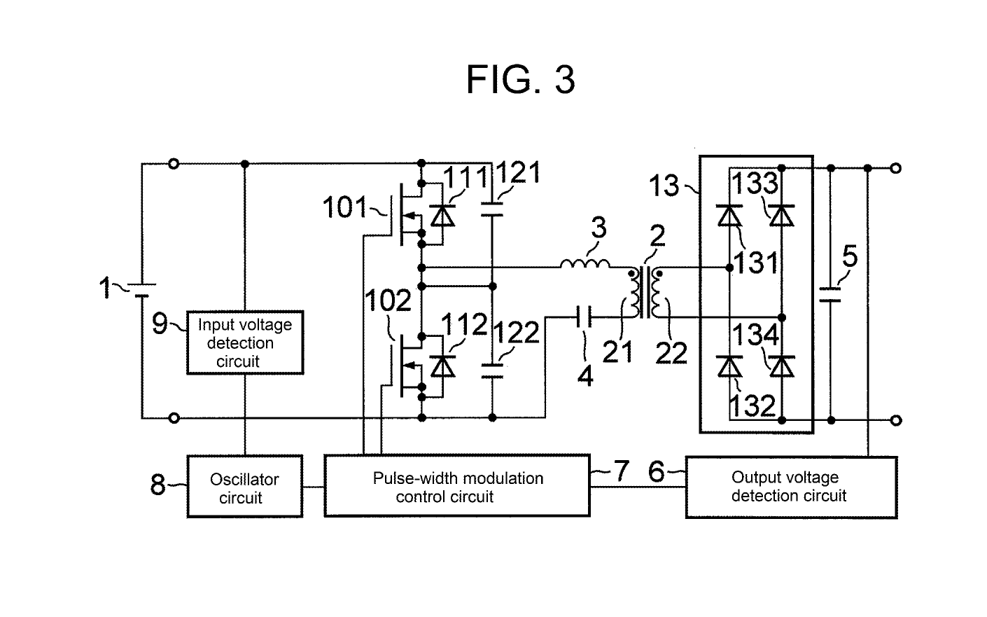

FIG. 1 is a circuit diagram showing a configuration of a DC-DC conversion device which is one embodiment of the invention. In FIG. 1, the configurations of a full-wave rectifier circuit 13 and a smoothing capacitor 5 provided on the secondary side of a transformer 2, and the configurations of an output voltage detection circuit 6, a pulse-width modulation control circuit 7, an oscillator circuit 8, and an input voltage detection circuit 9, are the same as those previously shown in FIG. 3.

In the DC-DC conversion device according to the embodiment, a first series arm wherein semiconductor switch elements 101 and 102 are connected in series is connected in parallel to, and a second series arm wherein semiconductor switch elements 103 and 104 are connected in series is connected in parallel to a direct current power source 1. Herein, in the first and second series arms, the semiconductor switch elements 101 and 103 are provided on the positive side of the direct current power source 1, while the semiconductor switch elements 102 and 104 are provided on the negative side of the direct current power source 1.

Also, a diode 111 and a capacitor 121 are connected in parallel to the semiconductor switch element 101, a diode 112 and a capacitor 122 are connected in parallel to the semiconductor switch element 102, a diode 113 and a capacitor 123 are connected in parallel to the semiconductor switch element 103, and a diode 114 and a capacitor 124 are connected in parallel to the semiconductor switch element 104. Herein, the diodes 111, 112, 113, and 114 are connected in parallel to the respective semiconductor switch elements 101, 102, 103, and 104 so that an input direct current voltage from the direct current power source 1 acts as reverse bias.

Further, a resonating reactor 3, a primary winding 21 of the transformer 2, and a resonating capacitor 4 are inserted in series between a common node between the semiconductor switch elements 101 and 102 and a common node between the semiconductor switch elements 103 and 104. In this way, the DC-DC conversion device according to the embodiment switches the input direct current voltage from the direct current power source 1 with a full bridge formed of the semiconductor switch elements 101, 102, 103, and 104, and gives an alternating current voltage to the primary winding 21 of the transformer 2.

The semiconductor switch elements 101, 102, 103, and 104 are power MOSFETs (Metal Oxide Semiconductor Field Effect Transistors) in the example shown in FIG. 1, but may be other semiconductor switch elements, such as IGBTs (Insulated Gate Bipolar Transistors) or bipolar transistors, which switch between ON and OFF in response to control signals.

The pulse-width modulation control circuit 7 generates a first pulse, which turns on the semiconductor switch elements 101 and 104, each time a synchronizing signal is given from the oscillator circuit 8, and subsequently, generates a second pulse, which turns on the semiconductor switch elements 102 and 103, in a period until a next synchronizing signal is given. The oscillator circuit 8 and the pulse-width modulation control circuit 7 configure pulse generating means which alternately generates the first and second pulses.

The output voltage detection circuit 6, in the same way as the one previously shown in FIG. 3, is a circuit which detects an output voltage of the DC-DC conversion device. Also, the pulse-width modulation control circuit 7, in accordance with an increase and a decrease in the output voltage, detected by the output voltage detection circuit 6, from a target value, carries out the control of decreasing the pulse width of the first pulse, thus increasing the pulse width of the second pulse by an amount equivalent to the decrease, or increasing the pulse width of the first pulse, thus decreasing the pulse width of the second pulse by an amount equivalent to the increase, and thereby maintains the output voltage value of the DC-DC conversion device at the target value. Also, the oscillator circuit 8 raises the frequency of synchronizing signals as the value of a voltage input into the DC-DC conversion device, detected by the input voltage detection circuit 9, increases, and lowers the frequency of the synchronizing signals as the input voltage value decreases.

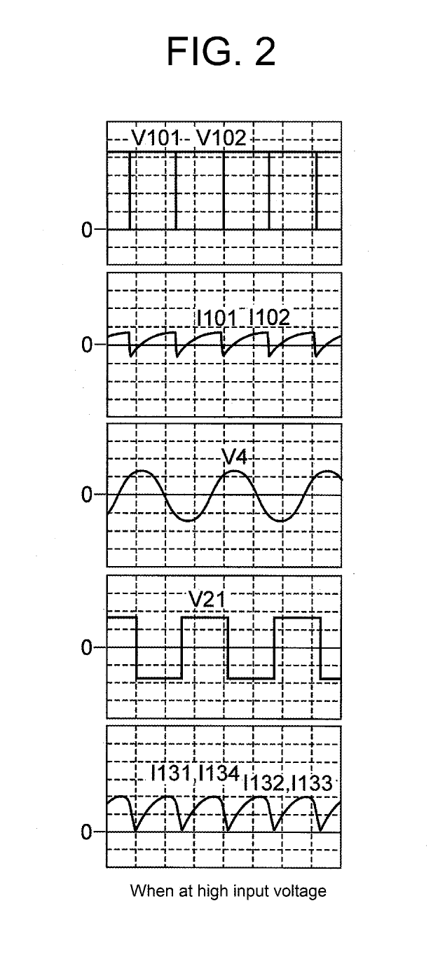

FIG. 2 is a waveform diagram showing an operation example of the DC-DC conversion device when at a high input voltage. FIG. 2 shows the respective waveforms of a drain-source voltage V101 of the semiconductor switch element 101, a drain-source voltage V102 of the semiconductor switch element 102, a drain current I101 of the semiconductor switch element 101, a drain current I102 of the semiconductor switch element 102, a voltage V4 of the resonating capacitor 4, a voltage V21 of the primary winding 21 of the transformer 2, and currents I131, I132, I133, and I134 flowing respectively through the diodes 131, 132, 133, and 134. Hereafter, a description will be given, referring to FIG. 2, of an operation of the embodiment.

When the pulse-width modulation control circuit 7 generates the first pulse, the semiconductor switch element 101 provided on the positive side of the direct current power source 1 in the first series arm, and the semiconductor switch element 104 provided on the negative side of the direct current power source 1 in the second series arm, are turned on. When the semiconductor switch elements 101 and 104 are turned on in this way, a resonant current I101 flows via a path from the direct current power source 1 through the semiconductor switch element 101, the resonating reactor 3, the primary winding 21 of the transformer 2, and the resonating capacitor 4 to the semiconductor switch element 104, and charging of the resonating capacitor 4 is carried out by the resonant current I101. During this time, a differential voltage between the input direct current voltage from the direct current power source 1 and the voltage V4 of the resonating capacitor 4 is applied to the primary winding 21 of the transformer 2 and the resonating reactor 3. Further, a voltage corresponding to the voltage V21 of the primary winding 21 is generated in a secondary winding 22 of the transformer 2, and the smoothing capacitor 5 is charged by the voltage via the diodes 131 and 134. Further, direct current power is supplied to an unshown load from the smoothing capacitor 5.

Next, the pulse-width modulation control circuit 7 causes the first pulse to fall and the second pulse to rise. When the first pulse falls and the semiconductor switch elements 101 and 104 are turned off, the resonant current having flowed so far is commutated to the capacitors 121, 122, 123, and 124, and the drain-source voltages of the semiconductor switch elements 101, 102, 103, and 104 rise or drop gradually.

When the drain-source voltages V101 and V104 of the turned-off semiconductor switch elements 101 and 104 reach the input direct current voltage from the direct current power source 1, the resonant current is commutated to the diodes 112 and 113. At this time, when the second pulse rises, the semiconductor switch element 102 provided on the negative side of the direct current power source 1 in the first series arm, and the semiconductor switch element 103 provided on the positive side of the direct current power source 1 in the second series arm, are turned on. As a result of this, a resonant current I102 flows via a path from the resonating capacitor 4 through the primary winding 21 of the transformer 2, the resonating reactor 3, the semiconductor switch element 102, and the direct current power source 1 to the semiconductor switch element 103, and discharging (or charging in a direction the reverse of that when the first pulse rises) of the resonating capacitor 4 is carried out by the resonant current I102. During this time, a differential voltage between the input direct current voltage from the direct current power source 1 and the voltage V4 of the resonating reactor 4 is applied to the primary winding 21 of the transformer 2 as the voltage V21. Further, a voltage corresponding to the voltage V21 of the primary winding 21 is generated in the secondary winding 22 of the transformer 2, and the smoothing capacitor 5 is charged by the voltage via the diodes 132 and 133. Further, direct current power is supplied to an unshown load from the smoothing capacitor 5.

Next, the pulse-width modulation control circuit 7 causes the second pulse to fall and the first pulse to rise. When the second pulse falls and the semiconductor switch elements 102 and 103 are turned off, the resonant current having flowed so far is commutated to the capacitors 121, 122, 123, and 124, and the drain-source voltages of the semiconductor switch elements 101, 102, 103, and 104 rise or drop gradually.

When the drain-source voltages V102 and V103 of the turned-off semiconductor switch elements 102 and 103 reach the input direct current voltage from the direct current power source 1, the resonant current is commutated to the diodes 111 and 114. At this time, when the first pulse rises, the semiconductor switch element 101 provided on the positive side of the direct current power source 1 in the first series arm, and the semiconductor switch element 104 provided on the negative side of the direct current power source 1 in the second series arm, are turned on. As a result of this, the resonant current I101 flows via a path from the direct current power source 1 through the semiconductor switch element 101, the resonating reactor 3, the primary winding 21 of the transformer 2, and the resonating capacitor 4 to the semiconductor switch element 104, and charging of the resonating capacitor 4 is carried out by the resonant current I101.

By this kind of operation being repeated, another direct current power isolated from the direct current power source 1 is generated based on the direct current power output by the direct current power source 1, and supplied to an unshown load via the smoothing capacitor 5.

In the DC-DC conversion device according to the embodiment, in the same way as in the DC-DC conversion device previously shown in FIG. 3, the oscillator circuit 8, when at a high input voltage, raises the frequencies of the first pulse which turns on the semiconductor switch elements 101 and 104 and the second pulse which turns on the semiconductor switch elements 102 and 103. As a result of this, switching of the semiconductor switch elements 101 and 104 from ON to OFF, and switching of the semiconductor switch elements 102 and 103 from ON to OFF, occur at a timing at which the current I101 flowing through the semiconductor switch element 101 is in the vicinity of the peak of the sine wave and at a timing at which the current I102 flowing through the semiconductor switch element 102 is in the vicinity of the peak of the sine wave. At this time, however, a breaking current flowing through the turned-off semiconductor switch elements 101 and 104 and a breaking current flowing through the turned-off semiconductor switch elements 102 and 103 decrease compared with the breaking currents flowing through the semiconductor switch elements previously shown in FIG. 3. The reason is as follows.

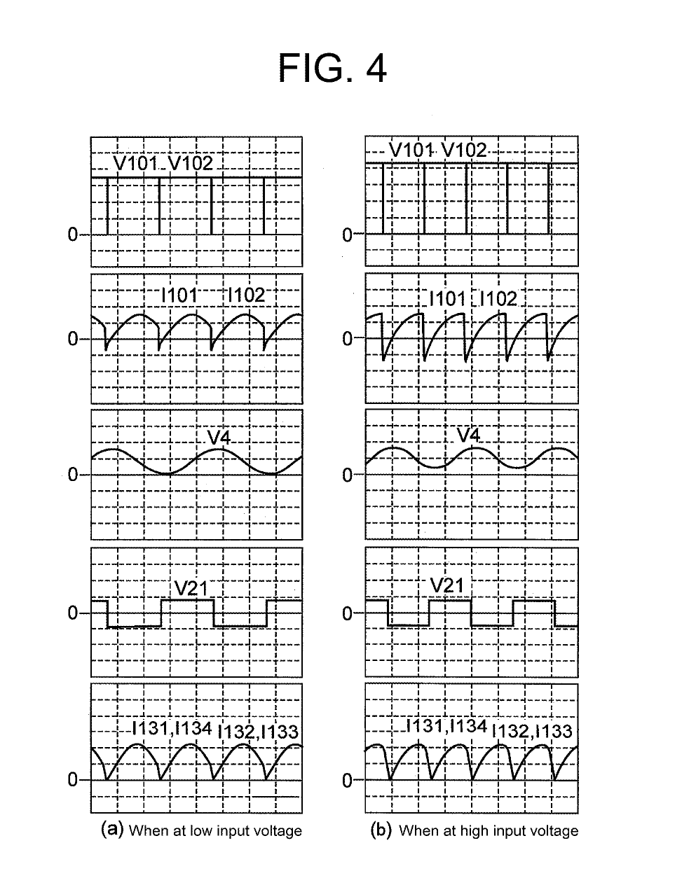

In the DC-DC conversion device previously shown in FIG. 3, one electrode of the resonating capacitor 4 is connected to the negative electrode of the direct current power source 1, and charging of the resonating capacitor 4 is carried out via the semiconductor switch element 101, while discharging of the resonating capacitor 4 is carried out via the semiconductor switch element 102. Because of this, the voltage V4 of the resonating capacitor 4 rises and drops repeatedly in a region of 0V or more, as shown in FIG. 4. Consequently, there is less room to widen the amplitude of the voltage V21 generated in the primary winding 21 of the transformer 2.

As opposed to this, in the DC-DC conversion device according to the embodiment, the resonating capacitor 4 is inserted between the common node between the semiconductor switch elements 101 and 102 and the common node between the semiconductor switch elements 103 and 104. Further, the operation of the semiconductor switch elements 101 and 104 being turned on to cause the current to flow through the resonating capacitor 4, and the operation of the semiconductor switch elements 102 and 103 being turned on to cause the current to flow through the resonating capacitor 4, are alternately repeated.

Herein, the current flowing through the resonating capacitor 4 in the period in which the semiconductor switch elements 101 and 104 are turned on, and the current flowing through the resonating capacitor 4 in the period in which the semiconductor switch elements 102 and 103 are turned on, are opposite in polarity. Because of this, the voltage V4 of the resonating capacitor 4 forms a waveform which oscillates in both positive and negative directions with 0V as a center, as shown in FIG. 2. Further, in the embodiment, a differential voltage between the input direct current voltage and the voltage V4 is applied to the primary winding 21 of the transformer 2 and the resonating reactor 3. In this way, the DC-DC conversion device according to the embodiment is such that it is possible in the configuration thereof to make the voltage V21 generated in the primary winding 21 of the transformer 2 higher than in the DC-DC conversion device previously shown in FIG. 3.

Consequently, according to the embodiment, when it is taken that the same direct current voltage as in the DC-DC conversion device previously shown in FIG. 3 is output, it is possible to increase a turn ratio n=n21/n22 of a number of turns n21 of the primary winding 21 of the transformer 2 to a number of turns n22 of the secondary winding 22 and thus increase the voltage V21 generated in the primary winding 21. Herein, the current flowing through the primary winding 21 of the transformer 2 is proportional to the reciprocal of the turn ratio n of the transformer 2. Consequently, in the embodiment, it is possible to increase the turn ratio n of the transformer 2 and thus decrease the current flowing through the primary winding 21 of the transformer 2. Because of this, it is possible to decrease the breaking current flowing through the semiconductor switch elements 101 and 104 when the semiconductor switch elements 101 and 104 are turned off and the breaking current flowing through the semiconductor switch elements 102 and 103 when the semiconductor switch elements 102 and 103 are turned off. Further, according to the embodiment, as it is possible to decrease the breaking currents of the semiconductor switch elements 101, 102, 103, and 104, it is possible to reduce switching losses of the semiconductor switch elements 101, 102, 103, and 104 particularly when at a high input voltage, and thus prevent a decrease in conversion efficiency. Also, according to the embodiment, as it is possible to decrease the current caused to flow through the primary winding 21 of the transformer 2, it is possible to reduce copper loss of the transformer 2. Also, according to the embodiment, as it is possible to decrease an effective current caused to flow through the resonating capacitor 4, it is possible to configure the DC-DC conversion device using an inexpensive resonating capacitor 4 with a low allowable effective current.

### Other Embodiments

A description has heretofore been given of one embodiment of the invention, but apart from this, other embodiments can be considered for the invention. Examples are as follows.

(1) The diodes 111, 112, 113, and 114 may be substituted for parasitic diodes interposed between the drains or sources of the semiconductor switch elements 101, 102, 103, and 104 and a semiconductor substrate forming the background thereof.

(2) The capacitors 121, 122, 123, and 124 may be substituted for parasitic capacitances interposed between the drains and sources of the semiconductor switch elements 101, 102, 103, and 104 and the semiconductor substrate forming the background thereof.

(3) The resonating reactor 3 may be substituted for the leakage inductance of the transformer 2.

### REFERENCE SIGNS LIST

1 . . . Direct current power source, 101, 102, 103, 104 . . . Semiconductor switch element, 111, 112, 113, 114, 131, 132, 133, 134 . . . Diode, 121, 122, 123, 124 . . . Capacitor, 2 . . . Transformer, 21 . . . Primary winding, 22 . . . Secondary winding, 3 . . . Resonating reactor, 4 . . . Resonating capacitor, 13 . . . Full-wave rectifier circuit, 5 . . . Smoothing capacitor, 6 . . . Output voltage detection circuit, 7 . . . Pulse-width modulation control circuit, 8 . . . Oscillator circuit, 9 . . . Input voltage detection circuit.

1. A DC-DC conversion device for use with a DC power source having a positive terminal and a negative terminal, comprising:
input stage means, connected to the DC power source, for generating AC power; and
output stage means for rectifying and smoothing the AC power generated by the input stage means,
wherein the input stage means includes:
a first series arm, formed by connecting first and second semiconductor switch elements in series, the first semiconductor switch element being connected to the positive terminal of the DC power source, and the second semiconductor switch element being connected to the negative terminal of the DC power source, the first and second semiconductor switch elements being connected to one another at a first node;
a second series arm, formed by connecting third and fourth semiconductor switch elements in series, the third semiconductor switch element being connected to the positive terminal of the DC power source, and the fourth semiconductor switch element being connected to the negative terminal of the DC power source, the third and fourth semiconductor switch elements being connected to one another at a second node;
first to fourth capacitors connected in parallel to the first to fourth semiconductor switch elements;
first to fourth diodes connected in parallel to the first to fourth semiconductor switch elements;
a resonating reactor;
a resonating capacitor, the resonating capacitor, the primary winding of the transformer, and the resonating reactor being connected in series between a common node between the first and second nodes;
an input voltage detection circuit which detects an input DC voltage received by the input stage means from the DC power source; and
pulse generating means which alternately and cyclically generates a first pulse which turns on the first and fourth semiconductor switch elements and a second pulse which turns on the second and third semiconductor switch elements, and which causes the frequencies of the first and second pulses to rise when the input direct current voltage is high and drop when the input direct current voltage is low, based on a result of the input direct current voltage detection in the input voltage detection circuit, so that a constant direct current voltage is output from the DC-DC conversion device without depending on the input direct current voltage.

2. The DC-DC conversion device according to claim 1,
wherein the pulse generating means includes an oscillator circuit that has a variable oscillating frequency and that generates synchronizing signals by oscillating, the first and second pulses being generated in response to the synchronizing signals generated by the oscillator circuit, and
wherein the pulse generating means causes the oscillating frequency of the oscillator circuit to rise when the input direct current voltage is high and drop when the input direct current voltage is low based on the result of the input DC detection by the input voltage detection circuit.

3. The DC-DC conversion device according to claim 2, further comprising:
an output voltage detection circuit which detects a DC voltage output by the output stage means,
wherein the pulse generating means, which generates the first and second pulses in response to the synchronizing signals output by the oscillator circuit, includes a pulse-width modulation control circuit which controls the respective pulse widths of the first and second pulses based on result of the DC voltage detection in the output voltage detection circuit so that the direct current voltage output by the output stage means maintains a target value.

4. The DC-DC conversion device according to claim 1, wherein the first to fourth capacitors are parasitic capacitances interposed in the first to fourth semiconductor switch elements.

5. The DC-DC conversion device according to claim 1, wherein the first to fourth diodes are parasitic diodes interposed in the first to fourth semiconductor switch elements.

6. The DC-DC conversion device according to claim 1, wherein the resonating reactor is provided by leakage inductance of the transformer.

7. The DC-DC conversion device according to claim 2, wherein the resonating reactor is provided by leakage inductance of the transformer.

8. The DC-DC conversion device according to claim 3, wherein the resonating reactor is provided by leakage inductance of the transformer.

9. A DC-DC conversion device for use with a DC power source having a positive terminal and a negative terminal, comprising:
input stage means, connected to the DC power source, for generating AC power; and
output stage means for rectifying and smoothing the AC power generated by the input stage means,
wherein the input stage means includes:
a first series arm, formed by connecting first and second semiconductor switch elements in series, the first semiconductor switch element being connected to the positive terminal of the DC power source, and the second semiconductor switch element being connected to the negative terminal of the DC power source, the first and second semiconductor switch elements being connected to one another at a first node;
a second series arm, formed by connecting third and fourth semiconductor switch elements in series, the third semiconductor switch element being connected to the positive terminal of the DC power source, and the fourth semiconductor switch element being connected to the negative terminal of the DC power source, the third and fourth semiconductor switch elements being connected to one another at a second node;
a series circuit connected between the first and second nodes, the series circuit including the primary winding of the transformer;
an input voltage detection circuit which detects an input DC voltage received by the input stage means from the DC power source; and
pulse generating means which alternately and cyclically generates a first pulse which turns on the first and fourth semiconductor switch elements and a second pulse which turns on the second and third semiconductor switch elements, and which causes the frequencies of the first and second pulses to rise when the input direct current voltage is high and drop when the input direct current voltage is low, based on a result of the input direct current voltage detection in the input voltage detection circuit, so that a constant direct current voltage is output from the DC-DC conversion device without depending on the input direct current voltage.
